(19) United States
(12) Patent Application Publication
(10) Pub. No.: US 2014/0216005 A1
(43) Pub. Date: Aug. 7, 2014

(54) Gas Turbine Engine Assembly Including A Thrust Reverser

(71) Applicant: UNITED TECHNOLOGIES CORPORATION, (US)

(72) Inventors: Dmitriy B. Sidelkovskiy, Ellinton, CT (US); Robert E. Malecki, Storrs, CT (US); Oleg Petrenko, Danbury, CT (US)

(73) Assignee: UNITED TECHNOLOGIES CORPORATION, Hartford, CT (US)

(21) Appl. No.: 13/630,234

(22) Filed: Sep. 28, 2012

(51) Int. Cl. F02K 1/72

(52) U.S. Cl. CPC F02K 1/72
USPC 60/226.2

(57) ABSTRACT

An exemplary gas turbine engine assembly includes a thrust reverser that is selectively moveable between a stowed position and a thrust reversing position. The thrust reverser includes an outer surface having a first outer surface area when the thrust reverser is in the stowed position and a second, smaller outer surface area when the thrust reverser is in the thrust reversing position.

### BACKGROUND

Gas turbine engines have been used on aircraft for many years. The engine is typically supported within a nacelle, which is supported on the aircraft. It is common for a nacelle to be suspended beneath an aircraft wing. This position of the nacelle can introduce some difficulties to accommodate wing slat movement.

For example, some engine configurations include a thrust reverser, which is a moveable portion of the nacelle. When the thrust reverser is in a stowed position, there may be enough clearance for desired movement of a wing slat. When the thrust reverser is in a thrust reversing position, however, a portion of the thrust reverser may be situated where it interferes with desired wing slat movement.

Various proposals have been made to address such a situation. One approach increases the spacing between the wing and the nacelle by mounting the nacelle further from the wing. This approach is undesirable at least from the standpoint that it adds weight. Another proposal changes the shape of the wing slat, which is undesirable from the standpoint that it can alter the take-off and landing performance of the aircraft. Other proposals include a flattened surface or a set of dents on the portion of the thrust reverser that faces the wing. A drawback associated with either of those approaches is that it increases drag during cruise conditions.

### SUMMARY

An exemplay gas turbine engine assembly includes, among other things, a thrust reverser that is selectively moveable between a stowed position and a thrust reversing position. The thrust reverser comprises an outer surface having a first outer surface area when the thrust reverser is in the stowed position and a second, smaller outer surface area when the thrust reverser is in the thrust reversing position.

In a further non-limiting embodiment of the foregoing gas turbine engine assembly, a thrust reverser outer shell has an outer surface area corresponding to the second outer surface area. The surface component is distinct from the thrust reverser outer shell. The surface component has an outer surface area that corresponds to a difference between the first outer surface area and the second outer surface area. The thrust reverser outer shell and the surface component collectively establish the first outer surface area.

In a further non-limiting embodiment of any of the foregoing gas turbine engine assemblies, the surface component is received against the thrust reverser outer shell when the thrust reverser is in the stowed position and the surface component is spaced from the thrust reverser outer shell when the thrust reverser is in the thrust reversing position.

In a further non-limiting embodiment of any of the foregoing gas turbine engine assemblies, the thrust reverser outer shell includes a cut out section and the surface component is received at least partially in the cut out section when the thrust reverser is in the stowed position.

In a further non-limiting embodiment of any of the foregoing gas turbine engine assemblies, the thrust reverser is moveable, relative to a nacelle stationary shell, between the stowed and thrust reversing positions. The surface component remains stationary relative to the nacelle stationary shell.

In a further non-limiting embodiment of any of the foregoing gas turbine engine assemblies, the surface component comprises a tab supported on the nacelle stationary shell.

In a further non-limiting embodiment of any of the foregoing gas turbine engine assemblies, a blocking member is at least partially received within the thrust reverser when the thrust reverser is in the stowed position. The surface component is supported on the blocking member.

In a further non-limiting embodiment of any of the foregoing gas turbine engine assemblies, the nacelle stationary shell has a leading edge and a trailing edge. The surface component comprises a section of the nacelle stationary shell along the trailing edge that is spaced from the leading edge by a greater distance than another section of the nacelle stationary shell along the trailing edge.

In a further non-limiting embodiment of any of the foregoing gas turbine engine assemblies, the thrust reverser includes an outer shell having a leading edge and a trailing edge. The leading edge includes a first section disposed around a first portion of a circumference of the leading edge, the first section being spaced from the trailing edge a first distance. The leading edge includes a second section along a second portion of the circumference of the leading edge that is spaced from the trailing edge a second, smaller distance.

Another exemplary gas turbine engine assembly includes, among other things, a thrust reverser including an outer shell having a leading edge and a trailing edge. The leading edge includes a first section disposed around a first portion of a circumference of the leading edge. The first section is spaced from the trailing edge by a first distance. The second section is disposed along a second portion of the circumference of the leading edge. The second section is spaced from the trailing edge by a second, smaller distance.

In a further non-limiting embodiment of the foregoing gas turbine engine assembly, a nacelle stationary shell has a leading edge and a trailing edge. The trailing edge of the nacelle stationary shell includes a first section spaced from the leading edge by a first distance and a second section spaced from the leading edge by a second, longer distance.

In a further non-limiting embodiment of either of the foregoing gas turbine engine assemblies, the first section of the thrust reverser outer shell leading edge is received against the first section of the nacelle stationary shell trailing edge and the second section of the thrust reverser outer shell leading edge is received against the second section of the nacelle stationary shell trailing edge when the thrust reverser is in a stowed position.

In a further non-limiting embodiment of any of the foregoing gas turbine engine assemblies, the second section of the leading edge of the thrust reverser outer shell comprises a cut out on the outer shell. The second section of the trailing edge of the nacelle stationary shell comprises a tab that is received in the cut out when the thrust reverser is in a stowed position.

In a further non-limiting embodiment of any of the foregoing gas turbine engine assemblies, the thrust reverser is moveable, relative to a nacelle stationary shell, between stowed and thrust reversing positions. The surface component has an outer surface that is received against the second section of the thrust reverser outer shell when the thrust reverser is in the stowed position. The surface component is spaced from the thrust reverser outer shell when the thrust reverser is in the thrust reversing position.

In a further non-limiting embodiment of any of the foregoing gas turbine engine assemblies, the surface component comprises a tab supported on the nacelle stationary shell.

In a further non-limiting embodiment of any of the foregoing gas turbine engine assemblies, a blocking member is at least partially received within the thrust reverser when the thrust reverser is in the stowed position. The surface component is supported on the blocking member.

In a further non-limiting embodiment of any of the foregoing gas turbine engine assemblies, the thrust reverser includes an outer surface having a first outer surface area when the thrust reverser is in a stowed position and a second, smaller outer surface area when the thrust reverser is in a thrust reversing position.

In a further non-limiting embodiment of any of the foregoing gas turbine engine assemblies, a surface component is distinct from the thrust reverser outer shell. The outer shell has an outer surface area corresponding to the second outer surface area. The surface component has an outer surface area that corresponds to a difference between the first outer surface area and the second outer surface area. The outer shell and the surface component collectively establish the first outer surface area.

Another exemplary gas turbine engine assembly includes, among other things, a nacelle stationary shell and a thrust reverser including an outer shell that is moveable relative to the nacelle stationary shell between a stowed position wherein the outer shell is received against the nacelle stationary shell and a thrust reversing position wherein the outer shell is spaced from the nacelle stationary shell. The thrust reverser has an outer surface, a first portion of the outer surface being established by the outer shell of the thrust reverser. A surface component is distinct from the outer shell, a second portion of the outer surface of the thrust reverser being established by the surface component when the thrust reverser is in the stowed position.

In a further non-limiting embodiment of the foregoing gas turbine engine assembly, the surface component comprises a tab supported on the nacelle stationary shell.

In a further non-limiting embodiment of either of the foregoing gas turbine engine assemblies, a blocking member is at least partially received within the thrust reverser when thrust reverser is in the stowed position. The surface component is supported on the blocking member.

In a further non-limiting embodiment of any of the foregoing gas turbine engine assemblies, the thrust reverser outer surface has a first outer surface area when the thrust reverser is in the stowed position and a second, smaller outer surface area when the thrust reverser is in the thrust reversing position.

In a further non-limiting embodiment of any of the foregoing gas turbine engine assemblies, the outer shell has an outer surface area corresponding to the second outer surface area. The surface component has an outer surface area that corresponds to a difference between the first outer surface area and the second outer surface area. The outer shell and the surface component collectively establish the first outer surface area.

In a further non-limiting embodiment of any of the foregoing gas turbine engine assemblies, the outer shell includes a cut out section. The surface component is least partially received in the cut out section when the outer shell is in the stowed position.

In a further non-limiting embodiment of any of the foregoing gas turbine engine assemblies, the surface component is received against the thrust reverser outer shell when the thrust reverser is in the stowed position. The surface component is spaced from the thrust reverser outer shell when the thrust reverser is in the thrust reversing position.

The various features and advantages of disclosed examples will become apparent to those skilled in the art from the following detailed description. The drawings that accompany the detailed description can be described as follows.

### BRIEF DESCRIPTION OF THE DRAWINGS

FIG. 1 is a schematic view of an example gas turbine engine.

FIG. 2 schematically illustrates a gas turbine engine assembly designed according to an embodiment of this invention.

FIGS. 3A and 3B schematically illustrate the embodiment shown in FIG. 2 in another operating condition.

FIG. 4 is a cross-sectional illustration taken along the lines 4-4 in FIG. 3.

FIG. 5 is a cross-sectional illustration of another example embodiment from a perspective similar to that shown in FIG. 4.

### DETAILED DESCRIPTION

Disclosed example aircraft components provide an arrangement that allows for realizing the benefits of a thrust reverser while accommodating moveable wing features such as a wing slat. An aircraft incorporating any of the example gas turbine engine assembly configurations includes an efficient use of limited space between a wing and a turbine engine. The following description includes a description of an example engine configuration followed by a description of example nacelle configurations.

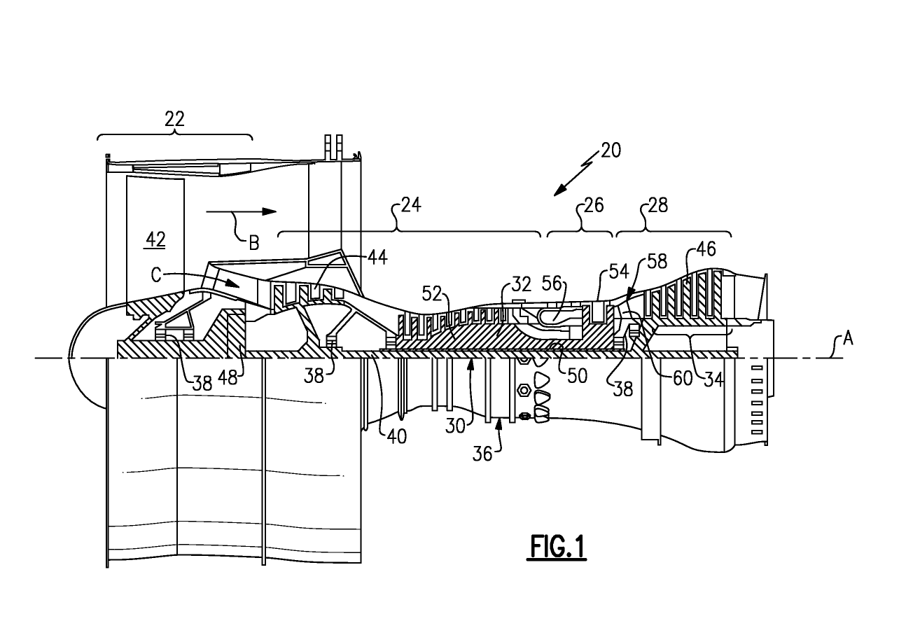

FIG. 1 schematically illustrates an example gas turbine engine 20 that includes a fan section 22, a compressor section 24, a combustor section 26 and a turbine section 28. Alternative engines might include an augmenter section (not shown) among other systems or features. The fan section 22 drives air along a bypass flow path B while the compressor section 24 draws air in along a core flow path C where air is compressed and communicated to the combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts disclosed in this description and the accompanying drawings are not limited to use with turbofans as the teachings may be applied to other types of turbine engines, such as a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high-speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used in this description, a “high pressure” compressor or turbine experiences a higher pressure than a corresponding “low pressure” compressor or turbine.

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 and sets airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6), with an example embodiment being greater than about ten (10). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram °R)/518.7) ^{0.5}]. The “Low corrected fan tip speed”, according to one non-limiting embodiment, is less than about 1150 ft/second.

The example gas turbine engine includes the fan 42 that comprises in one non-limiting embodiment less than about 26 fan blades. In another non-limiting embodiment, the fan section 22 includes less than about 20 fan blades. Moreover, in one disclosed embodiment the low pressure turbine 46 includes no more than about 6 turbine rotors schematically indicated at 34. In another non-limiting example embodiment the low pressure turbine 46 includes about 3 turbine rotors. A ratio between the number of fan blades 42 and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades 42 in the fan section 22 disclose an example gas turbine engine 20 with increased power transfer efficiency.

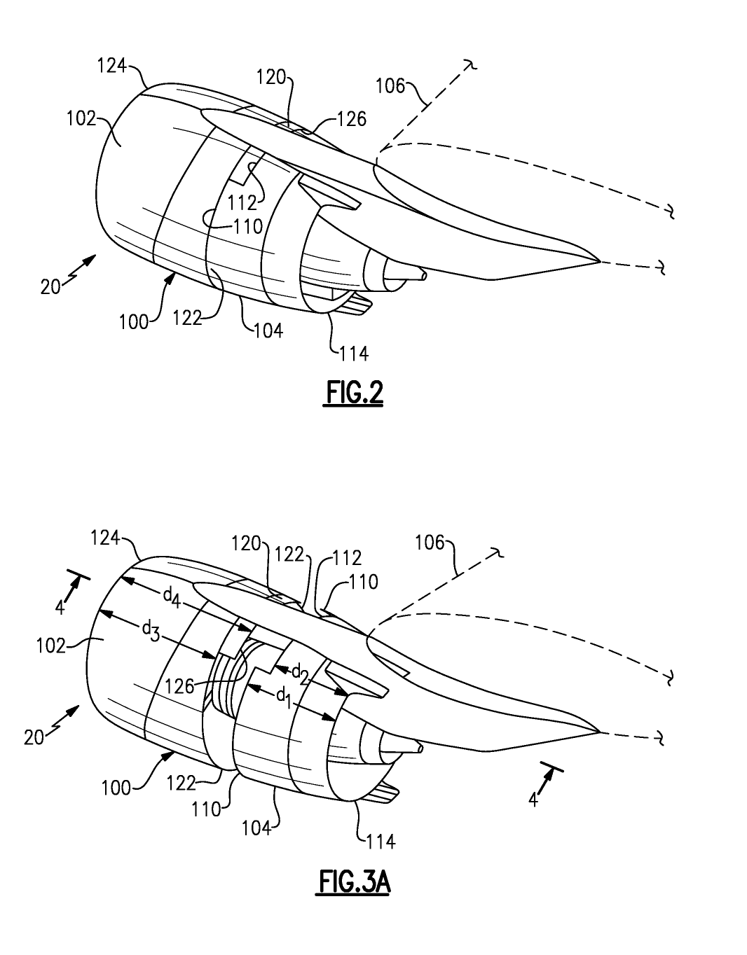

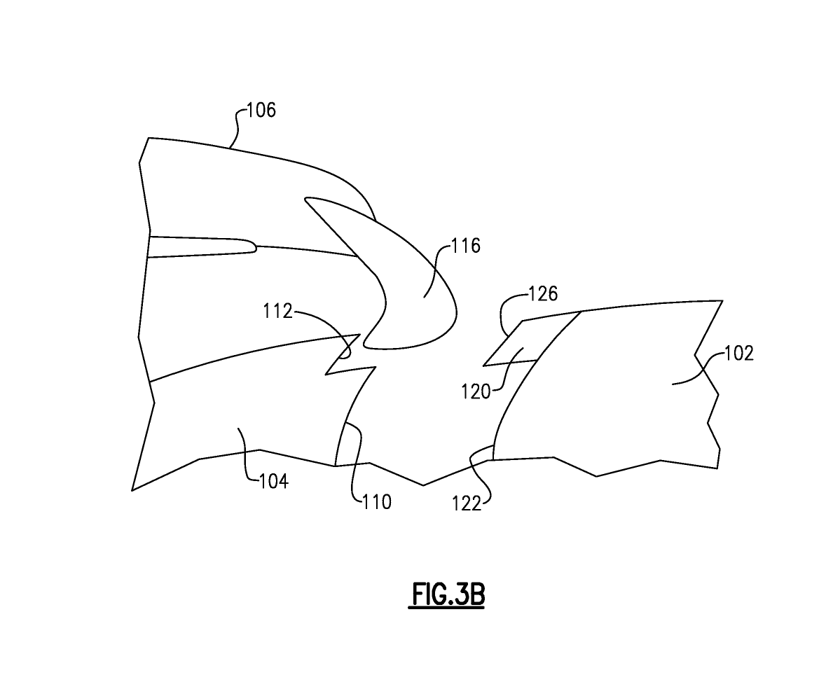

FIGS. 2 and 3A schematically illustrate a nacelle 100 that establishes a housing for the example gas turbine engine 20. The nacelle in this example has features that accommodate moveable wing slat components during thrust reversal. The nacelle 100 includes a stationary nacelle shell 102. The nacelle 100 also includes a thrust reverser 104 that is moveable relative to the stationary nacelle shell 102.

The nacelle 100 is supported beneath an aircraft wing 106 (shown partially in phantom) in a generally known manner. The stationary nacelle shell 102 is considered stationary from the standpoint that it remains in a fixed position relative to the wing 106, for example. As can be appreciated from the drawings, the thrust reverser 104 is moveable (relative to the stationary nacelle shell 102 and the wing 106) between a stowed position shown in FIG. 2 and a thrust reversing position shown in FIGS. 3a and 3b. The thrust reverser 104 provides a thrust reversing function in a generally known manner.

The thrust reverser 104 comprises an outer shell having a leading edge that faces toward the nacelle stationary shell 102. In this example, the leading edge includes a first reverser section 110 along a substantial portion of a circumference of the leading edge. Another, second reverser section 112 of the leading edge is situated differently than the section 110 and is illustrated as aft of the first reverser section 110.

In the illustrated example, the first section 110 of the leading edge of the outer shell of the thrust reverser 104 is spaced from a trailing edge 114 of the outer shell by a distance d₁. The second section 112 is spaced from the trailing edge 114 by a second distance d₂. In the illustrated example, the second distance d₂ is shorter than the first distance d₁. In other words, the section 110 is spaced from the trailing edge 114 by a larger distance than the distance between the second section 112 of the leading edge and the trailing edge 114.

The section 112 is illustrated as being defined by a cut out in the reverser 104 in this example. The cut out along the section 112 provides additional clearance between the thrust reverser 104 and an aircraft wing to accommodate wing slat movement, for example. FIG. 3B shows an example position of a wing slat 116 where the sing slat 116 is at least partially received within a space established by the cut out that defines the section 112. Without that cut out, there would be interference between the position of the wing slat 116 and the thrust reverser 104. Utilizing a cut out (i.e., the section 112) on the thrust reverser 104 improves the ability to avoid interference between the thrust reverser 104 and any wing components, such as the wing slat 116.

The illustrated assembly avoids drawbacks associated with previous thrust reverser configurations by including a surface component 120 that is distinct from the outer shell of the thrust reverser 104. The surface component 120 cooperates with the outer shell of the thrust reverser 104 for establishing a generally continuous surface contour along a corresponding section of the thrust reverser 104 at least when the thrust reverser 104 is in the stowed position (shown in FIG. 2). The surface component 120 is received at least partially within the cut out that defines the section 112 in the illustrated example.

In the example of FIGS. 2 and 3, the surface component 120 is situated adjacent the nacelle stationary shell 102. In this example, a trailing edge of the nacelle stationary shell 102 includes a first nacelle section 122 that extends along a substantial portion of a circumference of the shell 102. The first nacelle section 122 is spaced from a leading edge 124 of the shell 102 by a distance d₃.

In the illustrated example, the surface component 120 effectively establishes a second nacelle section of the trailing edge of the nacelle stationary shell 102. The trailing edge 126 of the surface component 120 is spaced aft of the leading edge 124 by a distance d₄. In this example, the distance d₄ is greater than the distance d₃. As can be appreciated in FIG. 2, the first section 110 along the thrust reverser leading edge is received against the first section 122 of the nacelle stationary shell trailing edge when the thrust reverser 104 is in the stowed position. The second section 112 of the thrust reverser leading edge is received against the trailing edge 126 of the surface component 120 in this example.

The surface component 120 and the outer shell of the thrust reverser 104 cooperate to establish an outer surface of the thrust reverser 104 when it is in the stowed position. The outer shell of the thrust reverser 104 establishes the outer surface of the thrust reverser 104 when it is in the thrust reversing position.

The outer surface of the thrust reverser 104 has a first reverser surface area when the thrust reverser 104 is in the thrust reversing position (shown in FIGS. 3A and 3B). In this example, the outer surface area of the thrust reverser 104 in the thrust reversing position is established by the outer surface area of the outer shell of the thrust reverser 104. The surface component 120 has a component outer surface area. A combined outer surface area of the outer shell of the thrust reverser 104 and the surface component 120 establishes a larger outer surface area of the thrust reverser 104 when it is in the stowed position compared to the outer surface area of the thrust reverser 104 when it is in the thrust reversing position. In other words, the thrust reverser 104 has a first outer surface area when the thrust reverser 104 is in the stowed position and a second, smaller outer surface area when the thrust reverser is in the thrust reversing position. The outer surface area of the surface component 120 in this example corresponds to a difference between the first outer surface area and the second outer surface area of the thrust reverser 104.

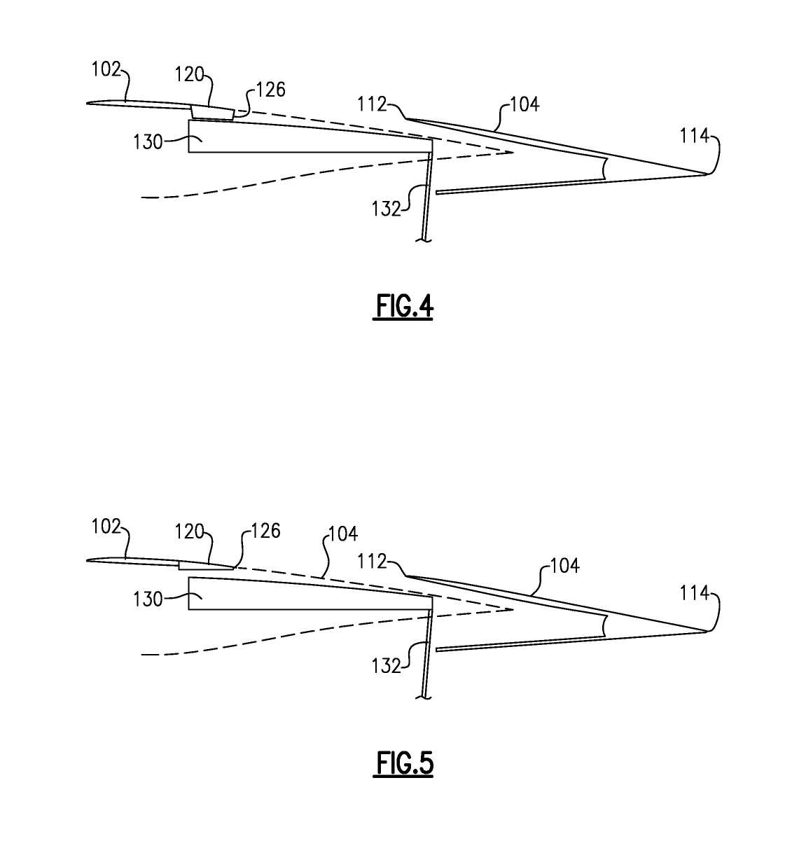

FIG. 4 is a cross-sectional illustration taken along the lines 4-4 in FIG. 3. The thrust reverser 104 is shown in the thrust reversing position in FIG. 4. The stowed position is represented in phantom in FIG. 4. As can be appreciated from the illustration, there is a space between the trailing edge 126 and the leading edge of second section 112 when the thrust reverser 104 is in the thrust reversing position. In this example, there is no spacing between the second section 112 of the leading edge of the thrust reverser 104 and the trailing edge 126 of the surface component 120 when the thrust reverser 104 is situated in the stowed position. In the stowed position the surface component 120 is received against and at least partially within the cut out (i.e., the second section 112) on the thrust reverser outer shell for establishing a substantially continuous outer surface contour along the corresponding portions of the nacelle 100.

In FIG. 4, the surface component is supported nearby but independent of the stationary shell 102. A blocking member or cascade blockage 130 is at least partially received within the outer shell of the thrust reverser 104 when the thrust reverser is in the stowed position. A blocker door 132 associated with the blocking member 130 is at least partially, schematically shown.

In the example of FIG. 4, the surface component 120 is supported on the blocking member 130. The trailing edge 126 of surface component 120 in this example is received against the second section 112 of the leading edge of the outer shell of the thrust reverser 104 when the thrust reverser 104 is in the stowed position. As can be appreciated from FIG. 4, when the thrust reverser 104 is in the thrust reversing position, there is spacing between the second section 112 of the leading edge of the outer shell of the thrust reverser 104 and the edge 126 on the surface component 120.

In the example of FIG. 5, the surface component 120 comprises a tab supported on the nacelle stationary shell 102. In some examples, the surface component 120 will be formed as part of the shell 102. In other examples, a separate component is supported on the shell 102 or otherwise situated to remain in a fixed position relative to the shell 102.

Other configurations of a surface component 120 and a cut out section of the outer shell of the thrust reverser 104 may be utilized. For example, the surface component 120 does not necessarily have to be immediately adjacent the nacelle stationary shell 102. Given this description, those skilled in the art will realize other positions that would be useful for a surface component 120 and a corresponding cut out on the outer shell of the thrust reverser 104. In one example, the cut out is situated in a central location of the body of the thrust reverser 104 instead of being near or at the leading edge as in the example of FIGS. 2 and 3. Additionally, the geometric configuration of the surface component 120 and the corresponding cut out section on the outer shell of the thrust reverser 104 may be varied from that of the illustrated example.

The disclosed gas turbine engine assembly configuration allows for achieving the benefits of having a thrust reverser while avoiding the drawbacks associated with potential space limitations when a thrust reverser is in a thrust reversing position. Additionally, the disclosed examples do not introduce additional drag under cruise conditions when the thrust reverser is in a stowed position. Additionally, the disclosed examples do not require any modification to the wing configuration and do not require increasing a distance between the nacelle and the wing structure.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A gas turbine engine assembly, comprising:
a thrust reverser that is selectively moveable between a stowed position and a thrust reversing position, the thrust reverser comprising an outer surface having a first outer surface area when the thrust reverser is in the stowed position and a second, smaller outer surface area when the thrust reverser is in the thrust reversing position.

2. The assembly of claim 1, comprising
a thrust reverser outer shell having an outer surface area corresponding to the second outer surface area; and
a surface component distinct from the thrust reverser outer shell, the surface component having an outer surface area that corresponds to a difference between the first outer surface area and the second outer surface area,
wherein the thrust reverser outer shell and the surface component collectively establish the first outer surface area.

3. The assembly of claim 2, wherein
the surface component is received against the thrust reverser outer shell when the thrust reverser is in the stowed position; and
the surface component is spaced from the thrust reverser outer shell when the thrust reverser is in the thrust reversing position.

4. The assembly of claim 3, wherein
the thrust reverser outer shell includes a cut out section; and
the surface component is received at least partially in the cut out section when the thrust reverser is in the stowed position.

5. The assembly of claim 2, comprising
a nacelle stationary shell, the thrust reverser being moveable relative to the nacelle stationary shell between the stowed and thrust reversing positions; and
wherein the surface component remains stationary relative to the nacelle stationary shell.

6. The assembly of claim 5, wherein the surface component comprises a tab supported on the nacelle stationary shell.

7. The assembly of claim 5, comprising a blocking member that is at least partially received within the thrust reverser when the thrust reverser is in the stowed position and wherein the surface component is supported on the blocking member.

8. The assembly of claim 5, wherein
the nacelle stationary shell has a leading edge and a trailing edge; and
the surface component comprises a section of the nacelle stationary shell along the trailing edge that is spaced from the leading edge by a greater distance than another section of the nacelle stationary shell along the trailing edge.

9. The assembly of claim 1, wherein the thrust reverser includes an outer shell having a leading edge and a trailing edge, the leading edge including a first section disposed around a first portion of a circumference of the leading edge, the first section being spaced from the trailing edge a first distance, the leading edge including a second section along a second portion of the circumference of the leading edge that is spaced from the trailing edge a second, smaller distance.

10. A gas turbine engine assembly, comprising:
a thrust reverser including an outer shell having a leading edge and a trailing edge, the leading edge including
a first section disposed around a first portion of a circumference of the leading edge, the first section being spaced from the trailing edge a first distance, and
a second section disposed along a second portion of the circumference of the leading edge, the second section being spaced from the trailing edge a second, smaller distance.

11. The assembly of claim 10, comprising a nacelle stationary shell having a leading edge and a trailing edge, the trailing edge of the nacelle stationary shell including a first section spaced from the leading edge by a first distance and a second section spaced from the leading edge a second, longer distance.

12. The assembly of claim 11, wherein the first section of the thrust reverser outer shell leading edge is received against the first section of the nacelle stationary shell trailing edge and the second section of the thrust reverser outer shell leading edge is received against the second section of the nacelle stationary shell trailing edge when the thrust reverser is in a stowed position.

13. The assembly of claim 11, wherein
the second section of the leading edge of the thrust reverser outer shell comprises a cut out on the outer shell; and
the second section of the trailing edge of the nacelle stationary shell comprises a tab that is received in the cut out when the thrust reverser is in a stowed position.

14. The assembly of claim 10, comprising
a nacelle stationary shell, the thrust reverser being moveable relative to the nacelle stationary shell between stowed and thrust reversing positions; and
a surface component having an outer surface that is received against the second section of the thrust reverser outer shell when the thrust reverser is in the stowed position, the surface component being spaced from the thrust reverser outer shell when the thrust reverser is in the thrust reversing position.

15. The assembly of claim 14, wherein the surface component comprises a tab supported on the nacelle stationary shell.

16. The assembly of claim 14, comprising a blocking member that is at least partially received within the thrust reverser when the thrust reverser is in the stowed position and wherein the surface component is supported on the blocking member.

17. The assembly of claim 10, wherein the thrust reverser includes an outer surface having a first outer surface area when the thrust reverser is in a stowed position and a second, smaller outer surface area when the thrust reverser is in a thrust reversing position.

18. The assembly of claim 17, comprising a surface component distinct from the thrust reverser outer shell, and
wherein
the outer shell has an outer surface area corresponding to the second outer surface area;
the surface component has an outer surface area that corresponds to a difference between the first outer surface area and the second outer surface area; and
the outer shell and the surface component collectively establish the first outer surface area.

19. A gas turbine engine assembly, comprising:
a nacelle stationary shell;
a thrust reverser including an outer shell that is moveable relative to the nacelle stationary shell between a stowed position wherein the outer shell is received against the nacelle stationary shell and a thrust reversing position wherein the outer shell is spaced from the nacelle stationary shell, the thrust reverser having an outer surface, a first portion of the outer surface being established by the outer shell of the thrust reverser; and
a surface component that is distinct from the outer shell, a second portion of the outer surface of the thrust reverser being established by the surface component when the thrust reverser is in the stowed position.

20. The assembly of claim 19, wherein the surface component comprises a tab supported on the nacelle stationary shell.

21. The assembly of claim 19, comprising a blocking member that is at least partially received within the thrust reverser when thrust reverser is in the stowed position and wherein the surface component is supported on the blocking member.

22. The assembly of claim 19, wherein the thrust reverser outer surface has a first outer surface area when the thrust reverser is in the stowed position and a second, smaller outer surface area when the thrust reverser is in the thrust reversing position.

23. The assembly of claim 22, wherein
the outer shell has an outer surface area corresponding to the second outer surface area;
the surface component has an outer surface area that corresponds to a difference between the first outer surface area and the second outer surface area; and
the outer shell and the surface component collectively establish the first outer surface area.

24. The assembly of claim 22, wherein
the outer shell includes a cut out section,
the surface component is at least partially received in the cut out section when the outer shell is in the stowed position.

25. The assembly of claim 19, wherein
the surface component is received against the thrust reverser outer shell when the thrust reverser is in the stowed position; and
the surface component is spaced from the thrust reverser outer shell when the thrust reverser is in the thrust reversing position.
